(19) United States
(12) Patent Application Publication
(10) Pub. No.: US 2010/0084791 A1
(43) Pub. Date: Apr. 8, 2010

(54) METHODS OF MANUFACTURING FIBERS

(76) Inventors: Xingtao Wu, Wobum, MA (US); Yong Shi, Nutley, NJ (US)

Correspondence Address: Xingtao Wu, 229 Washington Street, Woburn, MA, 01801, US

(21) Appl. No.: 12/575,476

(22) Filed: Oct. 8, 2009

Related U.S. Application Data
(60) Provisional application No. 61/103,924, filed on Oct. 8, 2008.
(60) Provisional application No. 61/104,028, filed on Oct. 9, 2008.

(51) Int. Cl. B29C 67/00; B29C 55/22

(52) U.S. Cl. 264/441; 264/437; 264/108

(57) ABSTRACT

A method of fabricating micro- and nano-scale fiber comprises: spreading micro- and nano-scale particles into a liquid or fluid-like material prior to forcing portions of the liquid or fluid-like material that surround the particles to depart from the original liquid or fluid-like environment by using a force field; stretching to elongate the portions of the liquid or fluid-like material until the free ends of the stretched portions stop motion to complete fiber or fiber-like structures in micro- and nano-scales.

### CROSS-REFERENCE TO RELATED APPLICATIONS

The instant application claims priority from provisional application No. 61/103,924, filed on Oct. 8, 2008 and provisional application No. 61/104,028, filed on Oct. 9, 2008, the disclosure of which are incorporated herein by reference in their entirety.

### FIELD OF THE INVENTION

In general, the invention relates to fibers, in particular, the invention relates to the fabrication of micro- and nano-scale fibers.

### BACKGROUND OF THE INVENTION

Fiber is a class of materials that are continuous filaments or are in discrete elongated pieces, similar to lengths of thread. Human uses for fibers are diverse. They can be spun into filaments, string or rope, used as a component of composite materials, or matted into sheets to make products such as paper or felt. Traditionally, micro- and nano-scale fibers can be produced by electrospinning, a process that makes use of electrostatic and mechanical forces to spin fibers from the tip of a fine orifice or spinneret, capable of producing fibers of diameters ranging from 10 nm to several microns. Another conventional technique for producing nanofibers is spinning bi-component fibers in 1-3 denier filaments with from 240 to possibly as much as 1120 filaments surrounded by dissolvable polymer, and dissolving the polymer leaves the matrix of nanofibers, which can be further separated by stretching or mechanical agitation.

Besides the traditional practices, modern technologies (e.g. micromachining and nano-fabrications) are developing new synthetic methods for many new value added applications for fibers such as medical, filtration, barrier, wipes, personal care, composite, garments, insulation, and energy storage. For example, special properties of nanofibers make them suitable for a wide range of applications from medical to consumer products and industrial to high-tech applications for aerospace, capacitors, transistors, drug delivery systems, battery separators, energy storage, fuel cells, and information technology.

Based on modern technologies, the following methods for fabricating micro- and nano-scale fibers have been proposed: high-aspect-ratio micromachining, electron beam lithography, nanoimprint lithography, electrochemical nanoprinting, roll-based imprinting, nanomolding, reactive ion etching (RIE) grass formation, pattern masking and etching, imprinting fiber-embedded substrates followed by etching, and controlled liquid pulling using nano-probes. Each method has its unique advantages and disadvantages and the choice of a fiber fabrication process largely depends on a specific application. As a result, there is an ongoing effort to strike a balance between advantages and the cost for each existing method, and furthermore, there is an accompanying need to seek new fabrication methods in order to produce fibers in desirable fineness, geometry, aspect ratio, uniformity, distribution, and in controllable clustering manners (e.g. density, distribution pattern, interweaving manners, and angle with respect to the receiving substrate), and with low cost and high product rate.

### SUMMARY OF THE INVENTION

In general, the present invention relates to methods of fabricating micro- and nano-scale fibers by forcing a portion of a liquid or fluid-like material that surrounds a micro- and nano-scale particle to depart a liquid or fluid-like environment, thereby forming elongated micro- and nano-scale fibers by stretching the liquid or fluid-like portion along the forced motion path.

In one aspect, an embodiment of the invention features a method of fabricating micro- and nano-scale fibers by taking advantage of electrostatic force. The method comprises spreading micro- and/or nano-scale particles into a liquid or fluid-like material on a first object. A second object is brought into close proximity with the first object. An electric field is built in between the two objects to electrostatically force a portion of the liquid or fluid-like material that surrounds the particle to emanate from the first object. The emanated material and/or the particle, in departing away from the first object towards the second object, forms an elongated fiber by stretching one end of the emanated liquid or fluid-like portion along its motion path.

Various implementation designs of the invention may include one or more of the following options:

The two objects are preferred to be two flat substrates.

Not limited to positioning the two substrates in parallel with each other, the second substrate can have an orientation non-parallel to the first substrate.

Not limited to stationary substrates, the two substrates can have relative motions.

Not limited to the use of blank substrates, substrates can have pre-deposited film(s), and pre-patterned micro- or nano-scale structures (e.g. IC addressing, driving, and/or readout circuitries).

Not limited to flat substrates, the two substrates can have curved surfaces.

Not limited to stationary liquid or fluid-like surface, during the emanating process, the liquid can be activated by mechanical, acoustic, thermal, optical, and/or magnetic energies.

Not limited to materials that are liquid phase or fluid-like at room temperatures, the liquid and fluid-like materials can be obtained by heating up and other means of melting materials.

Not limited to electrically neutral particles, particles can carry pre-charges.

Not limited to particles with the same material and uniform sizes, particles can be different in sizes and/or materials, and can be constructed with various transducer materials.

Not limited to constant electric field, the electric field can be built with varying strength, polarization, and waveforms (e.g. triangular, sinusoid, square, sawtooth and pulsed waves, and/or their combination).

Not limited to constant electric field, staged electric fields can be adopted in a time sequential manner in order to control the motion trajectory of the emanating material.

Not limited to using a flat substrate, the first object can be a liquid container that carries the liquid or fluid-like material with the particles, and be brought to close proximity with an electrode object in order to create an electric field with sufficient strength.

In another aspect, an embodiment of the invention features a method of fabricating micro- and nano-scale fiber structures by taking advantage of magnetic force. The method comprises spreading micro- and/or nano-scale magnetic particles into a liquid or fluid-like material on a first object. A second object is brought into close proximity with the first object. A magnetic field is built in between and around the two objects to magnetically force particles to emanate from the first object. An emanated magnetic particle, carrying a portion of the liquid or fluid-like material surrounding its surfaces, by departing away from the first object towards the second objects, forms an elongated fiber by stretching one end of the emanated liquid or fluid-like portion along its motion path.

Various implementation designs of the invention may include one or more of the following options:

The two objects are preferred to be two flat substrates.

Not limited to positioning the two substrates in parallel with each other, the second substrate can have an orientation non-parallel to the first substrate.

Not limited to stationary substrates, the two substrates can have relative motions.

Not limited to the use of blank substrates, substrates can have pre-deposited film(s), and pre-patterned micro- or nano-scale structures (e.g. IC addressing, driving, and/or readout circuitries).

Not limited to flat substrates, the two substrates can have curved surfaces.

Not limited to stationary liquid surface, during the emanating process, the liquid can be activated by mechanical, acoustic, thermal, optical, or magnetic energies.

Not limited to materials that are liquid phase or fluid-like at room temperatures, the liquid and fluid-like materials can be obtained by heating up or other means of melting the materials.

Not limited to electrically neutral particles, particles can carry pre-charges.

Not limited to particles with the same material and uniform sizes, particles can be different in sizes and/or materials, and can be constructed with transducer materials.

Not limited to permanent magnetic field, the magnetic field can be built with varying strength, polarization, and waveforms (e.g. triangular, sinusoid, square, sawtooth and pulsed waves, and/or their combination).

Not limited to permanent magnetic field, staged magnetic fields can be adopted in a time sequential manner in order to control the motion trajectory of the emanating particles.

Not limited to using a flat substrate, the first object can be a liquid container carrying the particles and the liquid or fluid-like material, and be brought to close proximity with a magnetic object in order to create the magnetic field with sufficient strength.

In yet another embodiment, an embodiment of the invention features a method of fabricating micro- and nano-scale fiber structures by taking advantage of one or more types of physical forces that include electrostatic force, magnetic force, centrifugal force, and gravitational force. The method comprises spreading micro- and/or nano-scale magnetic particles into a liquid or fluid-like material on a first object. A second object is brought into close proximity with the liquid surface on the first object. At least one type of the force fields is built in between the two objects to force a portion of the liquid or fluid-like material to emanate from the first object. The emanated portion of the liquid or fluid-like material, in departing away from the first object towards the second objects, forms an elongated fiber by stretching one end of the emanated liquid or fluid-like portion along its motion path.

Various implementation designs of the invention may include one or more of the following options:

The two objects are preferred to be two flat substrates.

Not limited to positioning the two substrates in parallel with each other, the second substrate can have a non-parallel orientation with respect to the first substrate.

Not limited to stationary substrates, the two substrates can have relative motions.

Not limited to use blank substrates, substrates can have pre-patterned micro- or nano-scale structures (e.g. IC addressing, driving, and/or readout circuitries).

Not limited to flat substrates, the two substrates can have curved surfaces.

Not limited to stationary liquid or fluid-like surface, during the emanating process, the liquid or the fluid-like material can be activated by mechanical, acoustic, thermal, optical, and/or magnetic energies.

Not limited to materials that are liquid phase or fluid-like at room temperatures, the liquid and fluid-like materials can be obtained by heating up or other means of melting the materials.

Not limited to electrically neutral particles, particles can carry pre-charges.

Not limited to particles with the same material and uniform sizes, particles can be different in sizes and/or materials, and can be constructed with transducer materials.

Not limited to constant force fields, the force field used can be built with varying strength, polarization, and waveforms (e.g. triangular, sinusoid, square, sawtooth and pulsed waves, and/or their combination).

Not limited to constant force field, staged force fields can be adopted in a time sequential manner in order to control the motion trajectory of the emanating materials.

Not limited to using a flat substrate, the first object can be a liquid container carrying the particles and the liquid or fluid-like material, and be brought to close proximity with a second object in order to create a net force field with sufficient strength.

### BRIEF DESCRIPTION OF THE DRAWINGS

Systems and methods of varying scopes are described herein. Further aspects and advantages will become apparent by reference to and by reading the following detailed description of the preferred embodiments and the accompanying drawings, in which:

FIG. 1 is a schematic illustration of the principle of the fabrication process for forming micro- and nano-scale fiber structures by emanating a portion of the liquid or fluid-like material from a source object in accordance with the present invention.

FIG. 2 is a schematic illustration of a process for forming micro- and nano-scale fiber structures by using electrostatic force in accordance with one embodiment of the present invention.

FIG. 3 is a schematic illustration of a process for forming micro- and nano-scale fiber structures by using magnetic force in accordance with another embodiment of the present invention.

FIGS. 4A-C are schematic illustrations of the formation process of the micro- and nano-scale fibers that are emanated by the electrostatic force in accordance with the FIG. 2 embodiment of the present invention.

FIGS. 5A-B are schematic illustrations of the micro- and nano-scale fibers with the accompanying particles locating at different places in the fibers in accordance with the embodiments of the present invention.

FIG. 6 is the schematic illustration of a process capable of adjusting the dimensions of the manufactured micro- and nano-scale fiber in accordance with the embodiments of the present invention.

FIGS. 7A-D are the schematic illustrations of fabricating micro- and/or nano-scale fibers onto various receiving objects with vastly different curved surfaces in accordance with the embodiments of the present invention.

FIG. 8 is the schematic illustrations of a process of fabricating micro- and/or nano-scale fibers onto a receiving substrate that is oriented non-parallel with the first substrate in accordance with the embodiments of the present invention.

FIG. 9 is the schematic cross sectional view of a preferred embodiment in accordance with the present invention that is designed to facilitate releasing of the manufactured micro- and nano-scale fibers by using a sacrificial layer.

FIG. 10A is the schematic cross sectional view of a preferred embodiment for preparing the hierarchically dimensioned, micro- and/or nano-scale fiber materials in accordance with the present invention.

FIG. 10B is the schematic cross sectional view of another preferred embodiment for preparing the hierarchically dimensioned, micro- and/or nano-scale fiber materials in accordance with the present invention.

FIG. 11 is the schematic cross sectional view of a preferred embodiment of fabricating micro- and/or nano-scale fibers onto a receiving substrate by using more than one type of force field in accordance with the embodiments of the present invention.

### DETAILED DESCRIPTION OF THE INVENTION

To provide an overall understanding of the invention certain illustrative embodiments will now be described. Those skilled in the art will recognize that many alternative embodiments can be accomplished using the teachings of the present invention and that the methods described herein may be adapted, modified, and employed, and that such other additions and modifications will not depart from the scope hereof.

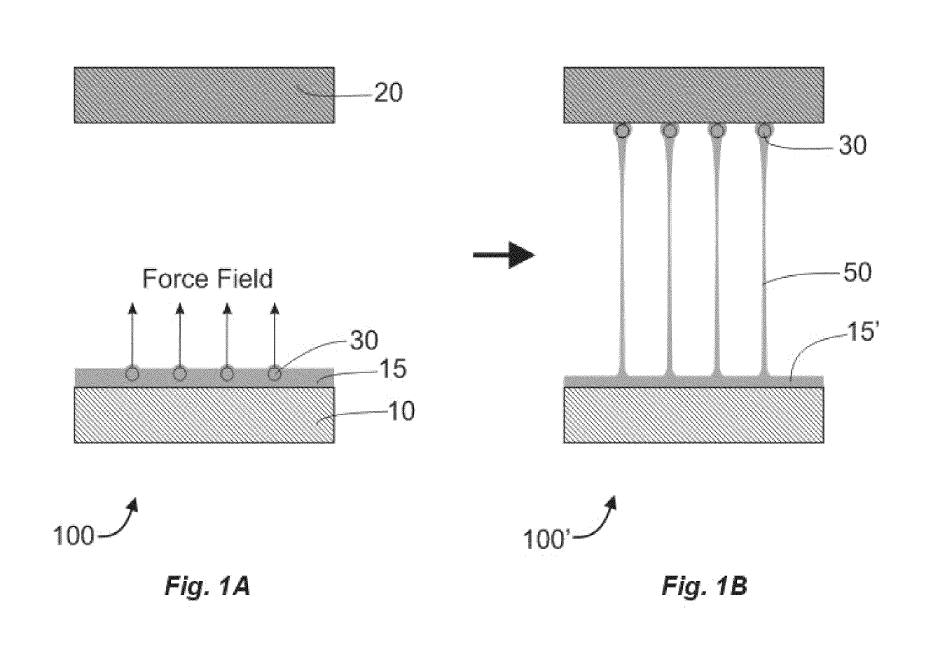

FIGS. 1A-B illustrate the concept of the fabrication process for forming micro- and nano-scale fibers by emanating particles from a liquid or fluid-like layer in accordance with the present invention. In FIG. 1A, the micro- or nano-scale particles 30, presumably all spread in a liquid or fluid-like layer 15 on a first object 10 (illustratively a flat substrate in FIG. 1A), are placed into a force field. In fabrication, the force field is chosen in a manner that the specific particles, once placed in the field, will impose on its surrounding liquid or fluid-like material to experience an overall pulling force, causing a portion of the liquid or fluid-like to depart away from the first substrate 10, but towards the second object (illustratively a flat substrate 20). In practice, this second substrate 20 serves as a target or a receiving substrate for the emanated materials including the particles 30 to land on. The second substrate 20 can usually be considered as a building element of the force field as well, for example, as an electrode in creating electric field, or for another example, being mounted with a coil (electromagnet) or permanent magnet to generate magnetic field. Depending on properties of the particles, the general force field can be built as electrostatic field, magnetic field, centrifugal force field, acoustic radiation, microwave radiation, gravitational field, and fluidic fields (e.g. flowing gas and differential pressures), and may be fashioned as combinations of any number of these types of forces.

Emanating event occurs when the pulling force offers sufficient strength and momentum to break the boundary stability near the liquid-particle and/or the liquid-air interfaces. For example, because of adhesion, a released particle will carry a portion of liquid residue surrounding its surface contour, and because of its liquid phase, the liquid residue is flexible in shaping and dimensions, with one end originating at the liquid layer 15 and the other end, i.e. the free end, binding with the emanating particle, following the motion of the particle, stretching and elongating the liquid residue to form fibers along the particle's motion path until this free end lands and dwells (by adhesion) on the target substrate 20. Thus, a fiber 50 is produced suspending between the first object 10 and the second object 20. Accordingly the liquid layer 15′, as shown in in FIG. 1B, has a reduced thickness because of the consumption of the material. Apparently, the liquid material is the fiber material, and any material capable of serving in form of liquid or fluid-like phase in the embodiment of FIG. 1A-B is able to provide a source for the fibers. Preferably, depending on specific applications, the fiber material can be fashioned from any number of different types of materials such as melted crystalline materials (e.g. silicon and gallium arsenide), metals, composites, and different polymeric materials including polymethylmethacrylate, polydimethylsiloxane, polyethylene, polyester, polyvinyl chloride, fluoroethylpropylene, lexan, polyamide, polyimide, polystyrene, polycarbonate, polypropylene, polybutylene, polyacrylate, polycaprolactone, polyketone, polyphthalamide, polysulfone, epoxy polymers, thermoplastics, fluoropolymer, and polyvinylidene fluoride, and other materials.

Wide range of material choices enables wide design freedoms for the fiber functionality. Not limited to serving solely as a elastic member, the fibers produced by using the methods according to the present invention can be concurrently feature designed as being electric conductive, semi-conductive, magnetic, piezoelectric, pyroelectric, piezoresistive, frictional, adhesive, or carrying residue charges (e.g. pollens with residue charges, silicon and silicon oxide particles with fixed charges and other residual charges), to name a few. Likewise, the micro- and nano-scale particles being in use can be made of all sorts of functioning materials.

The lengths, widths, spacing, shapes, densities, and other packing arrangements of the fibers may be varied by adjusting the parameters that specify the FIG. 1A embodiment according to the present invention. These parameters include sizes and spacing of the substrates 10 and 20, relative orientation of the two substrates, types of particles 30 and sizes, thickness of liquid layer 15, and types of force fields in use. For examples, the fiber length is largely determined by the substrate spacing, and the fiber width is largely in relevance to the sizes of the micro- and/or nano-scale particles, etc.

More sophisticated process control may be achieved by varying the objects and associating parameters of FIG. 1A embodiment in temporary domain. The force field, substrate orientation, spacing, positioning, and the agitating manner of the liquid layer 15 can be dynamically controlled. For examples, an electric field may be introduced with a waveform (e.g. triangular, sinusoid, square, sawtooth and pulsed waves, and/or their combination), the liquid layer 15 on the first object 10 may be thermally treated by a heating and/or cooling time sequence, and the relative orientation, positioning, and the spacing between the two substrates can follows a motion path and/or a control motion pattern.

As sufficient force strength is required to enable emanating process, the physical interaction of the liquid portions surrounding particles with a designed force field should be carefully considered in order to successfully employ the method. To build an electrostatic field, a preferable embodiment comprises using particles to modify field strength and distribution that locally surrounds the particle contour. For example, the dielectric property and sizes of a non-conducting particle may significantly influence the electric field strength at particle boundaries such that a significant stronger electrostatic force is induced to its surrounding liquid portions in contrast to the electrostatic force applied to pure liquid areas where no particles are present.

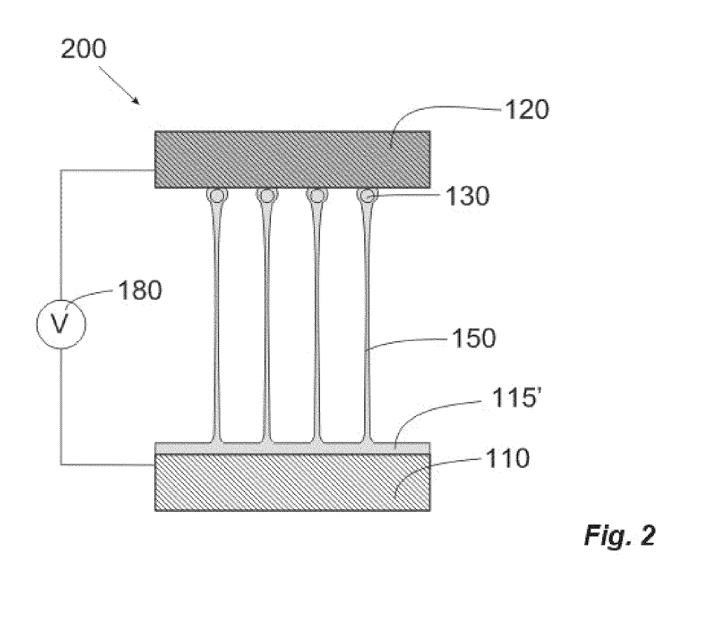

FIG. 2 illustrates a more specific embodiment of the present invention where electrostatic force field is employed. Shown in FIG. 2 is a schematic illustration of a process for forming micro- and nano-scale fiber structures by using electrostatic field in accordance with one embodiment of the present invention. The micro- or nano-scale particles 130 are presumably in a liquid (or fluid-like, or adhesive) layer 150 on a first object 110 (illustratively a flat substrate in FIG. 2). An electric field is created between the first object 110 and the second object 120 (illustratively also a flat substrate in FIG. 2) by a power source 180. As the liquid residue is flexible in shaping and dimensions, its free end thus moves with the emanating particle to stretch and elongate the liquid residue to form fibers 150. Accordingly the liquid layer 115′, as shown in FIG. 2, has a reduced thickness compared to that of the prior layer 115 because of the consumption of the liquid material.

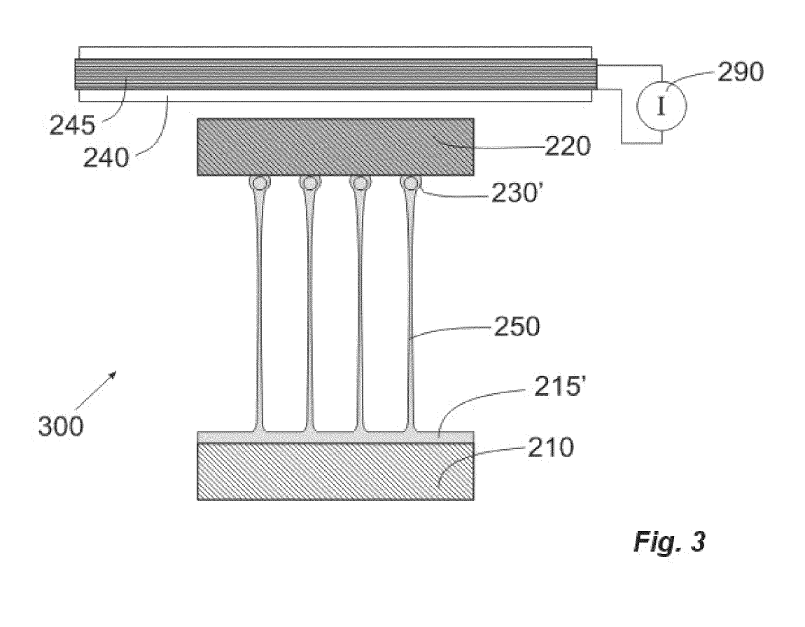

FIG. 3 illustrates another specific embodiment of the present invention where magnetic force field is employed. Shown in FIG. 3 is a schematic illustration of a process for forming micro- and nano-scale fiber structures by using magnetic field in accordance with another embodiment of the present invention. The micro- or nano-scale particles 230 are presumably in a liquid (or quasi-liquid) layer 250 on a first object 210 (illustratively a flat substrate in FIG. 3). A magnetic field is created between the first object 210 and the second object 220 (illustratively also a flat substrate in FIG. 3) by an electromagnet 240, of which a power source 290 is connected to its electromagnet coil 245 to generate the required magnetic field. Particles in this embodiment are preferred to be magnetic in order to response to the magnetic field efficiently to generate a pulling force. The magnetic pulling force can be either attractive or repulsive relying on the magnetic properties of particles and the polarization of the external magnetic field. The liquid material layer 250 in this embodiment may be designed with certain magnetic properties as well.

Similar to embodiment in using electrostatic force, particles emanate when the magnetic pulling force offers sufficient strength and momentum to break the boundary stability at the liquid-particle interface. Because of adhesion, a released particle will carry a portion of liquid residue surrounding its surface, and because of its liquid phase, the liquid residue is flexible in shaping and dimensions, with one end originating at the liquid layer 215 and another end, i.e. the free end, binding with the emanating particle. By following the motion of the particle, the liquid residue is thus stretched and elongated to form fibers along the particle's motion path until this free end lands and dwells (by adhesion) on the target substrate 220. As a result, a fiber 250 is produced suspending between the first object 210 and the second object 220. Accordingly the liquid layer 215′, as shown in FIG. 3, is reduced in thickness due to the consumption of the liquid material.

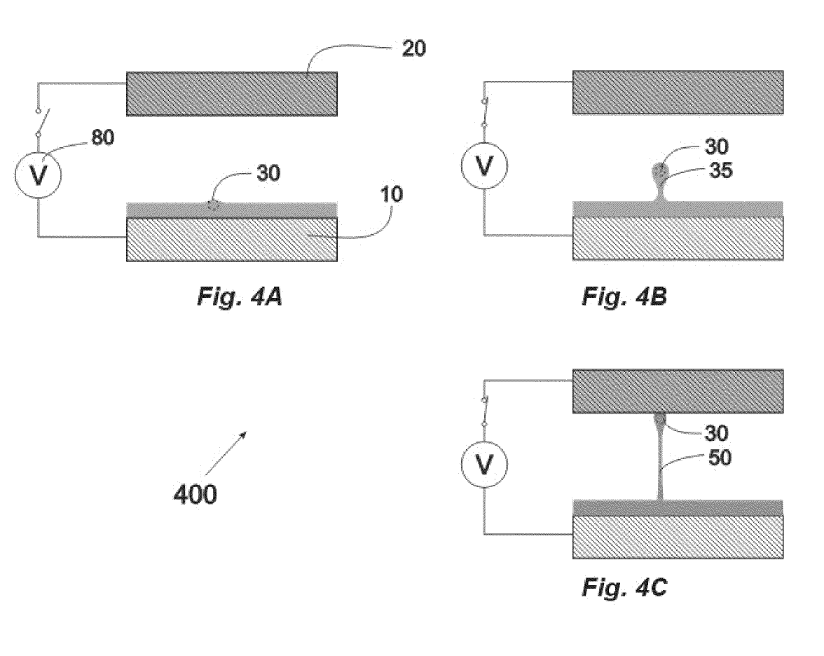

FIGS. 4A-C use the electrostatic force embodiment in FIG. 2 to illustrate the formation process of a fiber being emanated together with a particle. FIG. 4A shows the initial state of the embodiment in which the particle 30 is located near the liquid surface on the first substrate 10. A power source 80 is present and the switch is OFF. In FIG. 4B, the switch is set to ON to build an electric field between the two substrates 10 and 20. As a result, an electrostatic force is induced on the particle surface causing it to depart the first substrate 10 towards the substrate 20. The emanated particle meanwhile carries a portion of the liquid material through its journey towards the receiving substrate 20, and in between the initial and the current locations of the particle is thus spanned a portion of the liquid material 35. Such liquid portion (together with other portion of the liquid) is being continuously stretched and elongated until the particle manages to land on the receiving substrate 20, thereby forming a elongated and thinned fiber structure 50 along the particle's motion path.

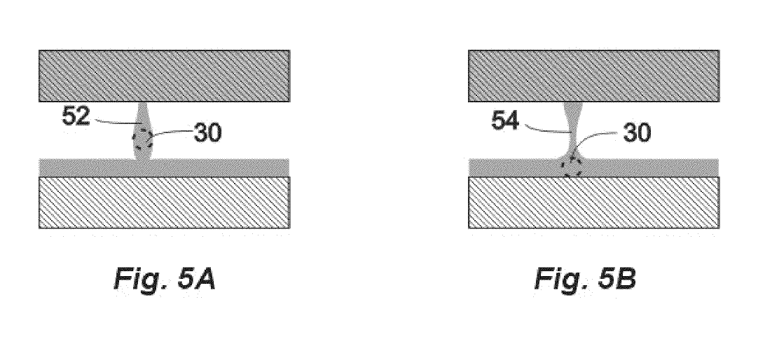

However, for all embodiments of the present invention, variations exist in that the particle is not more liable to move as the surrounding liquid does. The case is likely to occur when the electrostatic surface tension is sufficient to emanate a portion of the surrounding liquid while the effective pulling force (e.g. due to viscosity) on the particle is not strong enough to activate the latter in pace. As a result, the free end of an emanated liquid portion may be able to land on a receiving object while the accompanying particle 30 lags behind, locating itself between the two ends of the fiber structure 52, as shown in FIG. 5A. In extreme cases, the particle may not release from the first object at all while a portion of the liquid material has managed to reach the receiving substrate to form a fiber structure 54, as shown in FIG. 5B.

In summary, the micro- and nano-scale fibers, fabricated by using the various embodiments in accordance with the present invention, can locate the corresponding particle either between the two ends or at/near one of the fiber ends.

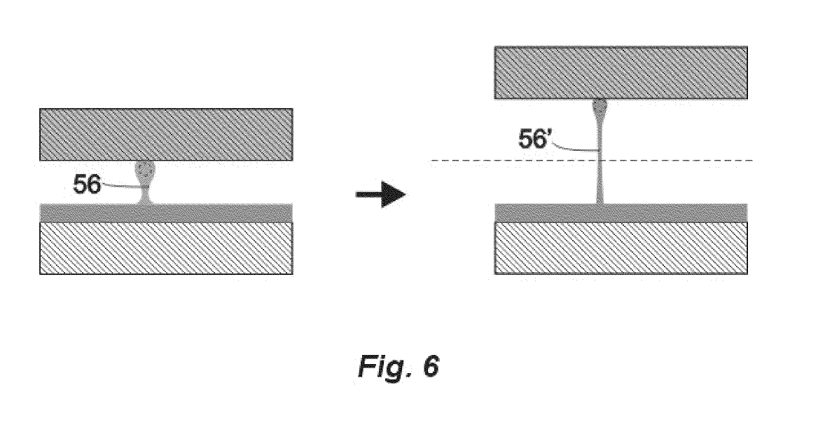

In order to adjust the fiber sizes (e.g. length and widths) and shapes, the spacing of the two objects 10 and 20 (e.g. substrates), as shown in FIG. 1, can be altered by mechanically moving one of the objects 10 and 20 or both. The operation may take place after the free end of the emanated liquid manages to dwell on the second object 20. Once a double fixed structure is achieved, as exemplarily shown in FIG. 6, the suspended structure can be further stretched (or pressed), and/or elongated (or shorten), and/or rotated, to form a fiber with a desirable length. In FIG. 6, by moving the second substrate to expand the substrate spacing, fiber 56 is elongated to become a fiber 56′ that is longer in length but reduced in width. The process may be reversible to fine tune the fiber dimensions. The process may be repeatable before the liquid portion is hardened, cured, or phase transformed to solid or solid-like.

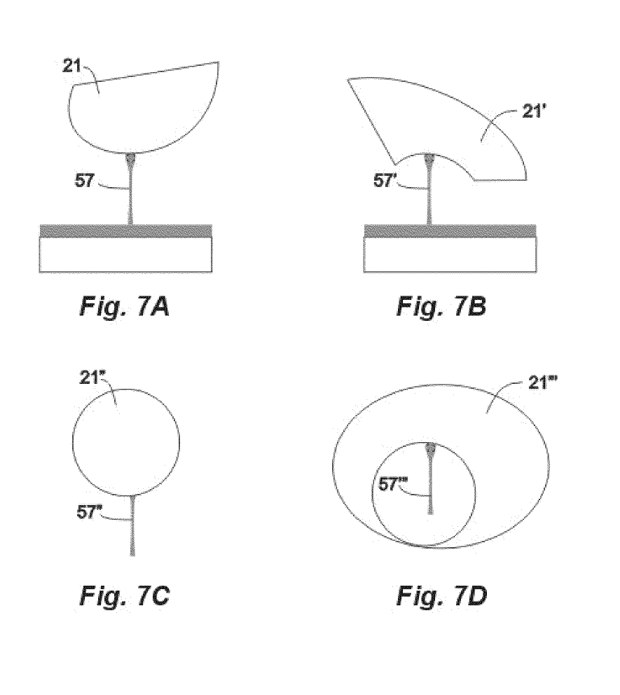

Not limited to emanating fibers onto flat receiving substrates, fibers can be fabricated onto surfaces with vastly different curvatures, as illustrated in FIGS. 7A-D. In FIG. 7A, fiber 57 is planted onto a concave surface of an object 21 by using the fabrication embodiment in accordance with the present invention. In FIG. 7B, fiber 57′ is planted onto a convex surface of an object 21′. In FIG. 7C and FIG. 7D, fibers 57″ and 57′″ are fabricated onto receiving objects 21″ and 21′″, respectively, wherein the object 21″ is a solid sphere and the object 21′″ is a hollowed part.

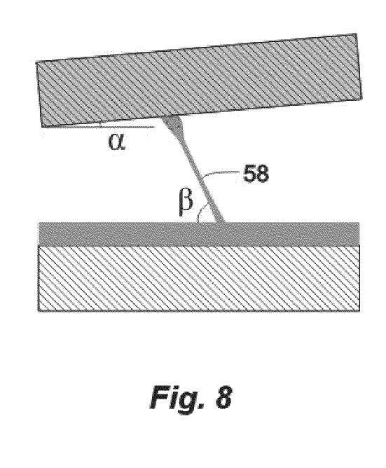

Refers back to FIG. 1 where the two objects 10 and 20 are illustrated as two substrates in parallel and are both stationary. However, the working concept of the FIG. 1 embodiment in accordance with the present invention allows as well non-parallel embodiment, as shown in FIG. 8, and in which the second substrate has an angular orientation of α with respect to the first substrate. As a result, the produced fiber 58, roughly assumed a straight fiber in FIG. 8, has an angular orientation of β with respect to the first substrate. Correspondingly, the fiber 58 has an angular orientation of α+β with respect to the receiving substrate, indicating the controllability of fiber orientations by using the fabrication embodiment in accordance with the present invention. Such a feature can be critical for generating micro- and nano-scale fibers for adhesive applications.

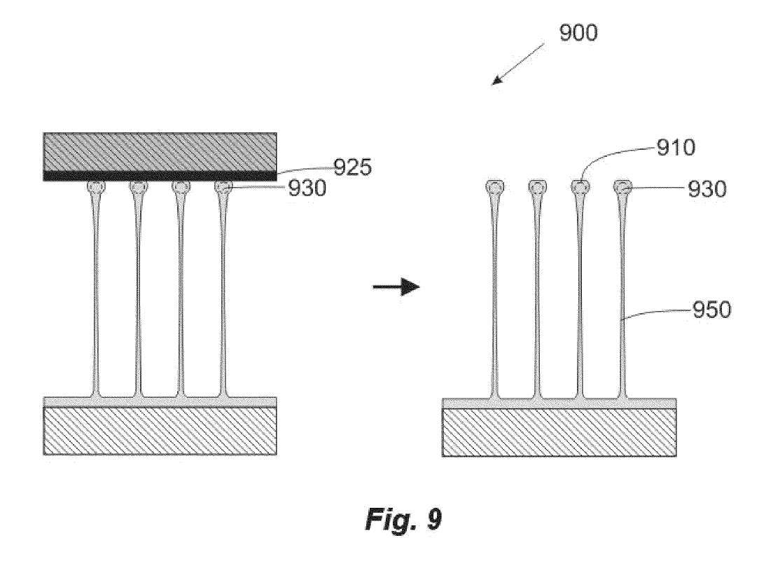

Referring now to FIG. 9, a schematic cross sectional view 900 of a preferred embodiment in accordance with the present invention is shown to illustrate incorporating a sacrificial layer 925 (e.g. silicon, silicon oxide, polymeric materials, to name a few) onto the receiving substrate to facilitate releasing of fibers. In FIG. 9, after the fibers are formed and the fiber material cured and/or hardened, the sacrificial layer 925 is thereafter removed and the receiving substrate becomes detachable from the entire embodiment. The produced fibers 950s are therefore equipped with free ends, and due to the good flatness and/or smooth roughness of the sacrificial layer 925, the fiber free ends may be able to inherit these surface features by replicating the surface interface. Thus, as shown in FIG. 9, the released free end of the fiber 950 gains a relative flat surface 910, well suited for applications where large surface contacts are desired.

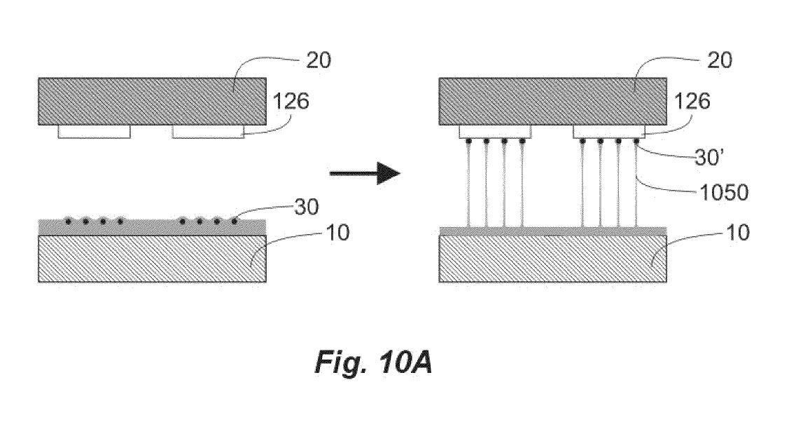

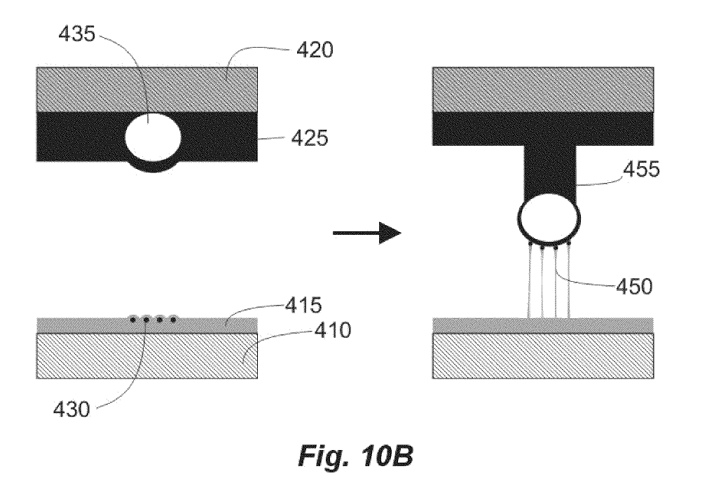

Additional embodiments of the present invention are directed to methods of preparing the hierarchically dimensioned, micro- and/or nano-scale fiber structures. Referring now to FIG. 10A, a schematic cross sectional view of a preferred embodiment in accordance with the present invention is shown to illustrate incorporating a pre-defined mesa or fiber structure 126 onto the receiving substrate 20. The surface facing the first substrate 10 on the member 126 is used to receive emanated fibers 1050. Member 126, when being designed as fiber or fiber-like structure, can also be fabricated by the method of the present invention, and more than two levels of hierarchies may be applied.

Instead of preparing the pre-defined fiber structure on a first substrate, the hierarchically dimensioned, micro- and/or nano-scale fiber structures can be manufactured in a concurrent manner. FIG. 10B illustrates a two-level fiber hierarchy being formed by the method of concurrent emanating in accordance with the present invention. Two opposing layers of liquid materials 415 and 425 (coated on two substrates 410 and 420, respectively) are spread with particles 430 and 435 having different sizes, respectively. In the process, fibers from two separate sources are emanated concurrently and their free ends join together by adhesion to form the fiber hierarchy. As shown in FIG. 10B, a larger fiber 455 formed with a particle 435 accommodates a plural of thinner fibers 450. Depending on the relative fiber sizes and densities, the fiber member 455 may be preferably designed to be micron-sized in cross section in order to allow many nano-scale fibers to dwell on.

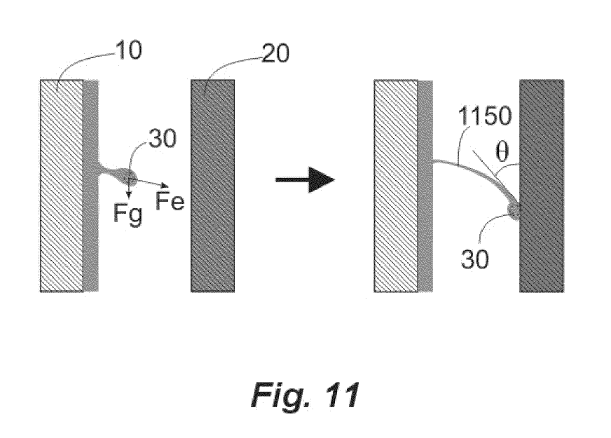

Referring now to FIG. 11, a schematic cross sectional view of a preferred embodiment in accordance with the present invention is shown to illustrate incorporating more than one type of force field to produce micro- and nano-scale fibers. In FIG. 11, both substrates 10 and 20 are oriented vertical and two types of force are employed—a gravitational force Fg and an electrostatic force Fe. Fiber 1150 is produced having a curved shape and with an angle θ with respect to the surface of the receiving substrate 20.

Although specific features of the invention are shown in some drawings and not in others, this is for convenience only as each feature may be combined with any or all of the other features in accordance with the invention. Moreover, any embodiments disclosed in the subject application are not to be taken as the only possible embodiments.

Other embodiments will occur to those skilled in the art and are within the following claims:

What is claimed is:

1. A method of forming micro- and/or nano-scale fiber comprising:
spreading micro- and/or nano-scale particle into a liquid or fluid-like material prior to forcing a liquid or fluid-like portion that surrounds the particle to depart from the liquid or fluid-like material by using a force field; and
stretching a portion of the liquid or fluid-like material that surrounds the particle to form an elongated fiber until
a free end of the stretched portion ends its motion.

2. The method of claim 1 wherein the force field is electrostatic field.

3. The method of claim 1 wherein the force field is magnetic field and the particle is a magnetic particle capable of being attracted and/or repelled in a magnetic field.

4. The method of claim 1 wherein the force field is formed by one of the following types of physical forces that include mechanical force, electrostatic force, magnetic force, centrifugal force, gravitational force, other inertial forces, and combinations thereof.

5. The method of claim 1 wherein the force field is a time-varying field

6. A method of forming micro- and/or nano-scale fiber comprising:
spreading micro- and/or nano-scale particle into a liquid or fluid-like material on a first object; and
building an electrostatic force field between the first object and a second object; and
forcing a portion of the liquid or the fluid-like material that surrounds the particle electrostatically to depart from the first object; and
stretching to elongate a portion of the liquid or the fluid-like material that surrounds the particle until the free end of the stretched portion is anchored to the second object; and
hardening the elongated liquid or fluid-like portion to create a micro- and nano-scale fiber.

7 The method of claim 6 wherein the first object has an electrode.

8. The method of claim 6 wherein the second object has an electrode.

9. The method of claim 6 wherein the first object is a substrate and the second object is a second substrate.

10. The first substrate of claim 9 is substantially in parallel to and opposes the second substrate of claim 9.

11. The first substrate of claim 9 is at least partially transverse with respect to the second substrate of claim 9.

12. The method of claim 6 wherein the created fiber has the particle locating at or near one of the fiber ends.

13. The method of claim 6 wherein the created fiber includes the particle between the fiber ends.

14. The method of claim 6 wherein the second object has at least one or more concave receiving surfaces for fiber to land on.

15. The method of claim 6 wherein the second object has at least one or more convex receiving surfaces for fiber to land on.

16. The method of claim 6 wherein the second object has at least one or more flat surfaces for fiber to land on.

17. The method of claim 6 wherein the second object has a pre-defined receiving structure for fiber to land on.

18. The method of claim 6 wherein the particle, before being applied with an electrostatic field, does not have initial charges on it.

19. The method of claim 6 wherein the particle, before being applied with an electrostatic field, has initial charges on it.

20. A method of forming hierarchically-dimensioned micro- and nano-scale fiber comprising:
spreading micro- and/or nano-scale particle of a first size into a first liquid or fluid-like material on a first object; and
spreading micro- and/or nano-scale particle of a second size into a second liquid or fluid-like material on a second object; and
building a force field between the first object and a second object; and
forcing both micro- and nano-scale particles to concurrently depart from the two objects, respectively; and
stretching to elongate portions of the two liquid or fluid-like materials that surround their respective particles until the free ends of the stretched portions join together; and
hardening the elongated liquid or fluid-like portions to create the hierarchically-dimensioned micro- and nano-scale fiber(s).
